(19) United States
(12) Patent Application Publication
(10) Pub. No.: US 2003/0154157 A1
(43) Pub. Date: Aug. 14, 2003

(54) Order generation via summary scan

(76) Inventors: Christopher Kokis, Monroe, CT (US); Robert A. Waghorne, FairField, CT (US)

Correspondence Address: DENIS G. MALONEY, Fish & Richardson P.C., 225 Franklin Street, Boston, MA, 02110-2804, US

(21) Appl. No.: 10/294,457

(22) Filed: Nov. 14, 2002

Related U.S. Application Data
(60) Provisional application No. 60/335,388, filed on Nov. 14, 2001.
(60) Provisional application No. 60/385,979, filed on Jun. 5, 2002.
(60) Provisional application No. 60/385,988, filed on Jun. 5, 2002.

(51) Int. Cl. G06F 17/60

(52) U.S. Cl. 705/37

(57) ABSTRACT

A securities order execution process includes an aggregated display process for displaying one or more groups of shares of a specific security that are traded on a securities market within a desired price range. A user selection process allows a market participant to select one or more of these groups of shares, thus generating a group of selected shares. A user order execution process executes an order concerning the group of selected shares.

### RELATED APPLICATIONS

This application claims the priority of: U.S. Provisional Patent Application No. 60/335,388, entitled “Super Montage”, and filed on Nov. 14, 2001; U.S. Provisional Patent Application No. 60/385,979, entitled “Supermontage Architecture”, and filed on Jun. 5, 2002; and U.S. Provisional Patent Application No. 60/385,988, entitled “Security Processor”, and filed on Jun. 5, 2002.

### BACKGROUND

This invention relates to electronic securities trading, and the processing and displaying of information relating to electronic securities trading.

Electronic equity markets collect, aggregate, and display pre-trade information to market participants. This pre-trade information takes the form of a quote that represents a single or an aggregate of same-priced principal or agency orders. A market, such as The Nasdaq Stock Market™, also provides trading platforms through which market participants may trade securities in the marketplace.

### SUMMARY

According to an aspect of this invention, a securities order execution process includes an aggregated display process for displaying one or more groups of shares of a specific security that are traded on a securities market within a desired price range. A user selection process allows a market participant to select one or more of these groups of shares, thus generating a group of selected shares. A user order execution process executes an order concerning the group of selected shares.

One or more of the following features may also be included. The aggregated display process includes a security selection process for selecting the specific security traded on the securities market. A price range specification process specifies the desired price range for the specific security.

The aggregated display process further includes an ask-side display process for displaying, in a multi-column format, an ask-side entry for each group of shares that represents shares of the specific security that are offered for sale by at least one market participant. Each of these ask-side entries includes an ask price, a lot size, and an ask-side aggregate value. The user selection process is configured to allow the market participant to select the group of selected shares by selecting each ask-side entry associated with that group of selected shares. The ask-side display process includes a tabular display process for simultaneously displaying multiple ask-side entries in an ask-side table. The ask-side display process further includes a tabular sorting process for sorting the multiple ask-side entries in accordance with a user-defined sorting parameter, such as the lot size, or the ask price. The ask-side display process further includes an ask-side aggregate calculation process for generating the ask-side aggregate value for a specific ask-side entry. This ask-side aggregate value is equal to the lot size of the specific ask-side entry summed with the lot sizes of all preceding ask-side entries included in the ask-side table.

The aggregated display process further includes a bid-side display process for displaying, in a multi-column format, a bid-side entry for each group of shares that represents shares of the specific security that are sought for purchase by at least one market participant. Each of these bid-side entries includes a bid price, a lot size, and a bid-side aggregate value. The user selection process is configured to allow the market participant to select the group of selected shares by selecting each bid-side entry associated with that group of selected shares. This bid-side display process is configured to display each bid-side entry such that it is essentially a mirror image of each ask-side entry. The bid-side display process includes a tabular display process for simultaneously displaying multiple bid-side entries in a bid-side table. The bid-side display process further includes a tabular sorting process for sorting the multiple bid-side entries in accordance with a user-defined sorting parameter, such as the lot size, or the bid price. The bid-side display process further includes a bid-side aggregate calculation process for generating the bid-side aggregate value for a specific bid-side entry. This bid-side aggregate value is equal to the lot size of the specific bid-side entry summed with the lot sizes of all preceding bid-side entries included in the bid-side table.

The aggregated display process further includes a display deactivation process for deactivating either the ask-side or bid-side display processes. The user order execution process includes an order confirmation process that requires the market participant to confirm the order prior to it being executed.

According to a further aspect of this invention, a securities order execution method includes: displaying one or more groups of shares of a specific security that are traded on a securities market within a desired price range; allowing a market participant to select one or more of these groups of shares, thus generating a group of selected shares; and executing an order concerning this group of selected shares.

One or more of the following features may also be included. Displaying one or more groups of shares includes selecting the specific security traded on the securities market, and specifying the desired price range for the specific security.

An ask-side entry is displayed, in a multi-column format, for each group of shares that represents shares of the specific security that are offered for sale by at least one market participant. Each of these ask-side entries includes an ask price, a lot size, and an ask-side aggregate value. The market participant is allowed to select the group of selected shares by selecting each ask-side entry associated with the group of selected shares. Multiple ask-side entries are simultaneously displayed in an ask-side table. The multiple ask-side entries are sorted in accordance with a user-defined sorting parameter. The ask-side aggregate value is generated for a specific ask-side entry, such that this ask-side aggregate value is equal to the lot size of that specific ask-side entry summed with the lot sizes of all preceding ask-side entries included in the ask-side table.

A bid-side entry is displayed, in a multi-column format, for each group of shares that represents shares of the specific security that are sought for purchase by at least one market participant, such that each bid-side entry includes a bid price, a lot size, and a bid-side aggregate value. The market participant is allowed to select the group of selected shares by selecting each bid-side entry associated with the group of selected shares. Each bid-side entry is displayed such that it is essentially a mirror image of each ask-side entry. Multiple bid-side entries are simultaneously displayed in a bid-side table. These multiple bid-side entries are sorted in accordance with a user-defined sorting parameter. The bid-side aggregate value is generated for a specific bid-side entry, such that the bid-side aggregate value is equal to the lot size of that specific bid-side entry summed with the lot sizes of all preceding bid-side entries included in the bid-side table. The displaying an ask-side entry and the displaying a bid-side entry can be selectively deactivated by the market participant. The market participant is required to confirm any order prior to it being executed.

According to a further aspect of this invention, a computer program product resides on a computer readable medium having a plurality of instructions stored on it. When these instructions are executed by the processor, they cause that processor to display one or more groups of shares of a specific security that are traded on a securities market within a desired price range. A market participant is allowed to select one or more of these groups of shares, thus generating a group of selected shares. An order is then executed concerning this group of selected shares.

One or more of the following features may also be included. The specific security traded on the securities market is selected by the market participant, who specifies the desired price range for that specific security. An ask-side entry is displayed, in a multi-column format, for each group of shares that represents shares of the specific security that are offered for sale by at least one market participant. Each ask-side entry includes an ask price, a lot size, and an ask-side aggregate value. The market participant selects the group of selected shares by selecting each ask-side entry associated with the group of selected shares. Multiple ask-side entries are simultaneously displayed in an ask-side table. These multiple ask-side entries are sorted in accordance with a user-defined sorting parameter. The ask-side aggregate value is generated for a specific ask-side entry, such that the ask-side aggregate value is equal to the lot size of that specific ask-side entry summed with the lot sizes of all preceding ask-side entries included in the ask-side table.

A bid-side entry is displayed, in a multi-column format, for each group of shares that represents shares of the specific security that are sought for purchase by at least one market participant. Each bid-side entry includes a bid price, a lot size, and a bid-side aggregate value. The market participant selects the group of selected shares by selecting each bid-side entry associated with the group of selected shares. Each bid-side entry is displayed such that it is essentially a mirror image of each ask-side entry. Multiple bid-side entries, which are simultaneously displayed in a bid-side table, are sorted in accordance with a user-defined sorting parameter. The bid-side aggregate value is generated for a specific bid-side entry, such that the bid-side aggregate value is equal to the lot size of that specific bid-side entry summed with the lot sizes of all preceding bid-side entries included in the bid-side table.

The displaying of the ask-side entries and bid-side entries can be selectively deactivated by the market participant. The market participant is required to confirm any order prior to it being executed.

One or more advantages can be provided from the above. The market participant can quickly and easily monitor all trading activity for a specific security. Additionally, by allowing the market participant to select the trading price range of the security they are monitoring, the summarized display can be filtered to remove the groups of the security that are outside of the market participant's price range. Further, by configuring the ask-side and bid-side of the display so that they are mirror images of each other, usability is increased due to easier readability and understandability. In addition, by allowing the market participant to directly order the securities being monitored, productivity and efficiency can be increased.

### DESCRIPTION OF DRAWINGS

FIG. 1 is a diagrammatic view of an order execution process;

FIG. 2 is a diagrammatic view of the summarized display generated by the order execution process of FIG. 1; and

FIG. 3 is a diagrammatic view of an order execution method.

### DETAILED DESCRIPTION

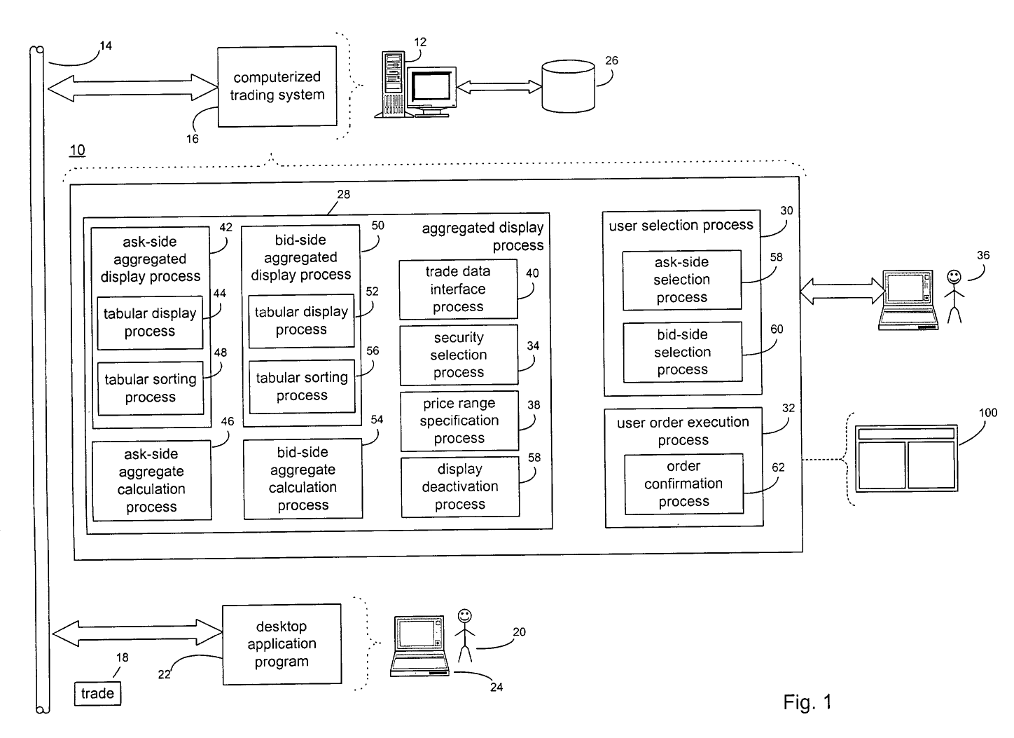

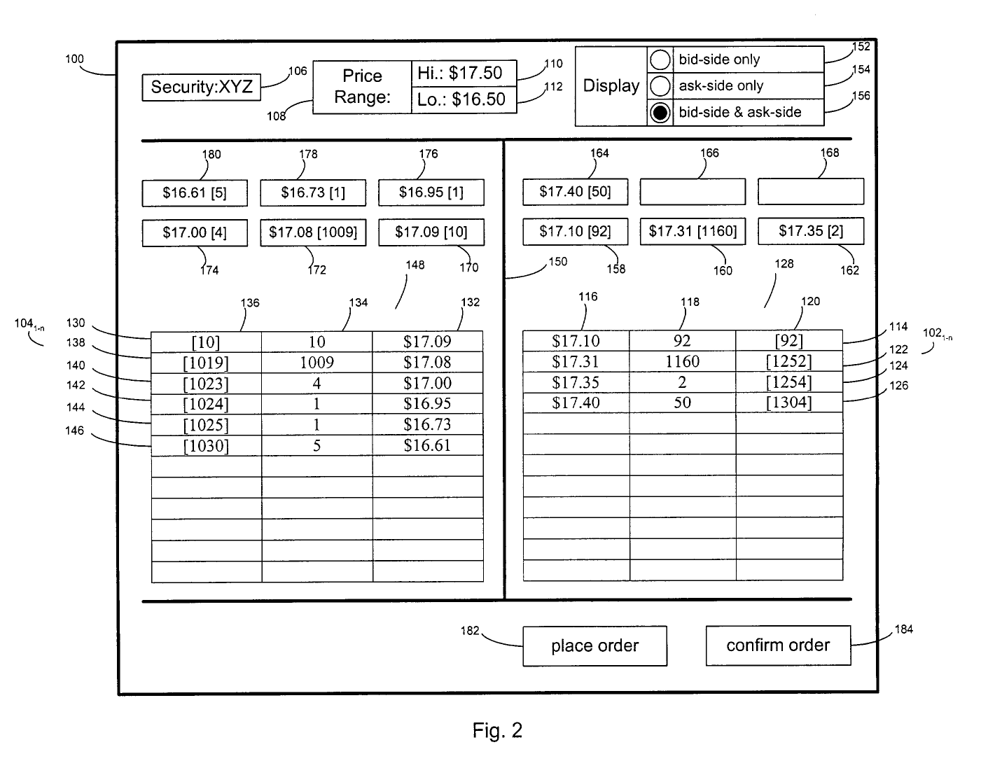

Referring to FIGS. 1 and 2, there is shown a securities order execution process 10. Order execution process 10 resides on server 12 that is connected to a distributed computing network 14 (e.g., the Internet, an intranet, a local area network, or some other form of network). Computerized trading system 16 (e.g., The Nasdaq Stock Market™), which trades securities electronically and also resides on server 12, processes trades 18 entered by market participant 20 (i.e., a market participant). Market participant 20 typically accesses and uses computerized trading system 16 via a desktop application 22 (e.g., Microsoft Internet Explorer™, Netscape Navigator™, the Nasdaq Workstation II™, a specialized desktop interface, etc.) residing on a computer 24, thus allowing market participant 20 to trade securities with other market participants (not shown).

Order execution process 10 allows market participant 20 to monitor the trading activity for a specific security traded on computerized trading system 16 (within a specified price range), and place orders concerning that security. Process 10 provides market participant 20 with a summarized display 100 concerning the specific security (to be discussed below in greater detail) that is viewable on computer 24. Typically, summarized display 100 is one screen in size, thus allowing market participant 20 to quickly get an overview of the activity of the specific security without having to scroll through or toggle between multiple screens. Through summarized display 100, market participant 20 can execute orders for the security that is summarized in display 100.

Process 10 typically resides on a storage device 26 connected to server 12. Storage device 26 can be a hard disk drive, a tape drive, an optical drive, a RAID array, a random access memory (RAM), or a read-only memory (ROM), for example. Additionally, computerized trading system 16 stores all information relating to securities trades on storage device 26.

Process 10 includes an aggregated display process 28 that displays one or more groups of shares 102₁₋ₙ, 104₁₋ₙ of a specific security 106 that is traded on computerized trading system 16. A user selection process 30 allows market participant 20 to select one or more of these groups of shares. Once these groups of shares are selected, a user order execution process 32 executes an order concerning these selected groups of shares. Therefore, summarized display 100 allows market participant 20 to monitor the trading activity for a particular security 106, such that the summarized display lists groups of shares 102₁₋ₙ, 104₁₋ₙ that are either offered for sale or sought for purchase. Through summarized display 100, market participant 20 can then select one or more of these groups of shares and execute an order, effectuating the purchase, sale, or purchase and sale of the selected groups of shares.

Aggregated display process 28 includes a security selection process 34 that allows market participant 20 to select the specific security 106 they wish to monitor. This selection may occur is several different ways and will vary depending on the manner in which process 34 is implemented and configured by administrator 36. For example, market participant 20 may select the security they wish to monitor via a drop-down menu (not shown) that allows the market participant to scroll through a list of securities to select the one they wish to monitor. This drop down menu may use ticker symbols or may list the full name of the issuer of the security. Alternatively, market participant 20 may wish to enter the security's ticker symbol directly, thus allowing for quicker selection.

Process 28 also includes a price range specification process 38 that allows market participant 20 to select a desired price range 108 for the specific security 106 they wish to monitor (i.e., the security market participant 20 selected with security selection process 34).

When securities are traded, outstanding offers to sell the security should have a higher price associated with them then the outstanding bids to buy the same security. Once the price of the bid to buy is equal to the price of the offer to sell, a trade of the security occurs. For example, if Market participant A wishes to sell one share of XYZ corp. for $10 but Market participant B, who wants to purchase one share of XYZ corp., is only willing to pay $9 for it, a trade of this security will not occur until: (a) Market participant A lowers their offer price to $9, (b) Market participant B raises their bid price to $ 10, or (c) the two market participants meet somewhere in the middle. Further, as there are typically multiple sellers, these sellers tend to offer their shares at different prices. Additionally, as there are also multiple buyers, these buyers tend to wish to purchase shares at different prices. Therefore, concerning a specific security, there is typically a wide range of prices that span from the very low bid to buy, through the actual trading value, and right up to the very high offer to sell.

Price range specification process 38 allows market participant 20 to define a price range for the specific security 106 they wish to monitor. This price range selection may occur is several different ways and will vary depending on the manner in which process 38 is implemented and configured by administrator 36. For example, market participant 20 may select the price range of securities they wish to monitor via a drop-down menu that allows the market participant to scroll through a list of price ranges and select the range they wish to monitor. Alternatively, market participant 20 may be able to manually enter an upper limit 110 and a lower limit 112. Additionally, market participant 20 may be able to enter a specific price (e.g., $10). Therefore, for this example, the range would be a fixed dollar amount in which the upper limit 110 is equal to the lower limit 112. Further, market participant 20 may be able to enter a wildcard descriptor (e.g., *) for either or both limits. Therefore, the range could be from negative infinity to positive infinity, resulting in all shares of the selected security being displayed (regardless of their offer/bid price). The use of price range specification process 38 by market participant 20 results in summarized display 100 being filtered to remove any shares of the specific security 106 that fall outside of the desired price range 108 selected by market participant 20.

Once a security 106 is selected and a desired price range 108 is specified, a trade data interface process 40 retrieves, from storage device 26 of server 12, the relevant trade data concerning the security selected by market participant 20. Typically, summarized display 100 is a real-time display, in that the information shown within the display is regularly updated (at a frequency defined by administrator 36) so that it is always accurate and up to date. Accordingly, trade data interface process 40 typically establishes a connection (i.e., a socket) with computerized trading system 16 so that the information provided in display 100 is always relevant and up-to-date.

Once a connection is established by trade data interface process 40 and the relevant trade data is retrieved, summarized display 100 is populated. As stated above, summarized display 100 allows market participant 20 to quickly and easily discern the trading activity associated with the specific security 106 that market participant 20 wishes to monitor, and select and purchase various groups of shares of that security.

An ask-side aggregated display process 42 displays, in a multi-column format, ask-side entries 102₁₋ₙ for the security that was selected by market participant 20, and is currently being traded on computerized trading system 16 in the desired price range 108 selected by market participant 20. Each discrete ask-side entry 102₁₋ₙ represents a discrete group of the specific security 106 selected by market participant 20, such that these groups of securities are being offered for sale by another market participant or group of market participants at a common price that is within the desired price range 108 specified by market participant 20. For example, assume that market participant 20 used security selection process 34 to select XYZ corp. as the specific security 106 they wish to monitor. Further, assume that market participant 20 used price range specification process 38 to enter a desired price range 108 of $16.50 (lower limit 112) to $17.50 (upper limit 110). Summarized display 100 would then be populated with ask-side entries 102₁₋ₙ that met the criteria specified by market participant 20.

Ask-side entry 114 concerns a group of ninety-two shares of the security XYZ corp. that is currently being offered for sale. Ask-side entry 114 includes multiple columns, each of which provides information concerning the discrete group of securities being offered for sale, such as an ask price 116 (i.e., the price requested by the market participant(s) for one share of XYZ corp.), a lot size 118 (i.e., the quantity of shares of the selected security available at that ask price from those market participants(s)), and an aggregate value 120 (i.e., the total sum of shares available at the ask price or lower).

Ask-side aggregated display process 42 includes a tabular display process 44 for simultaneously displaying multiple ask-side entries (e.g., ask-side entries 114, 122, 124, 126). These ask-side entries are arranged vertically so that the ask price, lot size, and aggregate value of each entry are aligned, forming ask-side table 128.

Therefore, for this particular summarized display 100, if market participant 20 is willing to pay up to $17.10 for a share of XYZ corp., market participant 20 could buy up to ninety-two shares for that price. This is shown in ask-side entry 114. However, if market participant 20 desires a ninety-third share of XYZ corp., market participant 20 is going to have to pay $17.31 for that one additional share (see ask-side entry 122), since there are only ninety-two shares of XYZ corp. for sale at $17.10. If market participant 20 wants to purchase additional shares of XYZ corp., they can purchase up to eleven-hundred-sixty shares for $17.31 per share (see ask-side entry 122).

Ask-side entries 114, 122, 124, 126 do not necessarily represent the shares available for a certain price from a single market participant. Conversely, the individual ask-side entries represent the combined total number of shares available of a specific security 102 for a specific asking price. Therefore, this combined total number of shares may be offered for sale by a single market participant or a group of market participants.

For example, assume that the total groups of shares of XYZ corp. offered for sale by the individual market participants trading on computerized trading system 16 are as follows:

| | Ask Price | Aggregate Value | Lot Size | Market Participant |
|---|---|---|---|---|
| Offer 1 | $17.10 | [92] | 92 | D |
| Offer 2 | $17.31 | [142] | 50 | M |
| Offer 3 | $17.31 | [253] | 111 | H |
| Offer 4 | $17.31 | [1252] | 999 | Y |
| Offer 5 | $17.35 | [1253] | 1 | Z |
| Offer 6 | $17.35 | [1254] | 1 | E |
| Offer 7 | $17.40 | [1304] | 50 | B |
| Offer 8 | $18.09 | [1305] | 1 | C |
| Offer 9 | $18.09 | [1309] | 4 | A |
| Offer 10 | $18.11 | [1310] | 1 | U |
| Offer 11 | $18.12 | [1311] | 1 | G |
| Offer 12 | $18.13 | [1312] | 1 | K |

In the above example, there are three market participants (namely Market participant M, Market participant H, and Market participant Y) that are offering shares of XYZ corp. for $17.31 per share. The combined number of shares of XYZ corp. offered by these three market participants for $17.31 is [50+111+999] for a total of eleven-hundred-sixty shares. These three separate and distinct offers (i.e., Offer 2, Offer 3, and Offer 4) are represented by ask-side entry 122. Further, Offer 1 is represented by ask-side entry 114, Offer 5 and Offer 6 are represented by ask-side entry 124, and Offer 7 is represented by ask-side entry 126. Further, Offers 8-12 are not represented in ask-side table 128, as they are greater than the upper limit 110 of desired price range 108.

Process 10 includes an ask-side aggregate calculation process 46 for calculating the ask-side aggregate value 116 for each ask-side entry. Ask-side aggregate calculation process 46 determines the ask-side aggregate value 120 for a particular ask-side entry by summing the value of the lot size for that particular ask-side entry with the lot sizes of all preceding ask-side entries included in ask-side table 128. For example, the aggregate value for ask-side entry 114 is [92], the aggregate value for ask-side entry 122 is [1252, i.e., 92+1160], the aggregate value for ask-side entry 124 is [1254, i.e., 92+1160+2], and so forth.

A tabular sorting process 48 sorts ask-side entries (e.g., 114, 122, 124, 126) in accordance with a user-defined sorting parameter, such as ascending or descending ask prices, ascending or descending lot sizes, for example. This enables market participant 20 to group and order the ask-side entries within ask-side table 128 in accordance with their personal preferences. However, the ask-side entries within ask-side table 128 are typically sorted by ask price (as shown in FIG. 2).

In a manner similar to ask-side aggregated display process 42, a bid-side aggregated display process 50 displays, in a multi-column format, bid-side entries 104₁₋ₙ for the same security (i.e., XYZ corp.) that was selected by market participant 20 and is currently being traded on computerized trading system 16 for a common price that is in the desired price range 108 selected by market participant 20. Each discrete bid-side entry 104₁₋ₙ represents a discrete group of the specific security 106 selected by market participant 20 that is sought for purchase by another market participant or group of market participants of computerized trading system 16. For example, bid-side entry 130 concerns a group of ten shares of the security XYZ corp. that a market participant or group of market participants currently wants to purchase for $17.09 per share. Similar to an ask-side entry, a bid-side entry includes multiple columns, each of which provides information concerning the discrete group of securities sought for purchase, such as a bid price 132 (i.e., the price that the market participant(s) would like to pay for one share of XYZ corp.), a lot size 134 (i.e., the quantity of shares of the selected security that the market participant(s) want to purchase at that bid price), and an aggregate value 136 (i.e., the total sum of shares sought for purchase at that bid price or higher).

Bid-side aggregated display process 50 includes a tabular display process 52 for simultaneously displaying multiple bid-side entries (e.g., bid-side entries 130, 138, 140, 142, 144, 146). These bid-side entries are arranged vertically so that the bid price, lot size, and aggregate value of each entry are aligned, forming an bid-side table 148.

Therefore, for this particular summarized display 100, if market participant 20 owns two-thousand shares of XYZ corp. that they are willing to sell for no less than $17.09 per share, market participant 20 can only sell ten shares, as bid-side entry 130 specifies that only ten shares of XYZ corp. are sought at $17.09 per share. However, if market participant 20 is willing to lower their sell price to $17.08 per share, they can sell one-thousand-nineteen shares of XYZ corp. at that price (i.e., $17.08) or better. Specifically, ten shares can be sold for $17.09 per share (see bid-side entry 130) and one-thousand-nine shares can be sold for $17.08 per share (see bid-side entry 138), for a total of one-thousand-nineteen shares.

Again, bid-side entries 130, 138, 140, 142, 144, 146 do not necessarily represent the shares sought for purchase by a single market participant at a certain price. Conversely, the individual bid-side entries represent the combined total number of shares sought for purchase at a certain price, regardless of the market participant(s) wishing to make the purchase. Therefore, this combined total number of shares may be sought by a single market participant or a group of market participants.

For example, assume that the total groups of shares of XYZ corp. sought for purchase by the individual market participants trading on computerized trading system 16 are as follows:

| | Bid Price | Aggregate Value | Lot Size | Market Participant |
|---|---|---|---|---|
| Bid 1 | $17.09 | [10] | 10 | A |
| Bid 2 | $17.08 | [20] | 10 | C |
| Bid 3 | $17.08 | [1019] | 999 | L |
| Bid 4 | $17.00 | [1020] | 1 | G |
| Bid 5 | $17.00 | [1021] | 1 | Z |
| Bid 6 | $17.00 | [1022] | 1 | M |
| Bid 7 | $17.00 | [1023] | 1 | R |
| Bid 8 | $16.95 | [1024] | 1 | A |
| Bid 9 | $16.73 | [1025] | 1 | L |
| Bid 10 | $16.61 | [1030] | 5 | Q |
| Bid 11 | $16.44 | [1031] | 1 | Z |
| Bid 12 | $16.11 | [1036] | 5 | P |

Notice that there are two market participants (namely Market participant C, and Market participant L) that are bidding $17.08 per share for shares of XYZ corp. The combined number of shares of XYZ corp. sought by these two market participants at $17.08 per share is [10+999] for a total of one-thousand-nine shares. These two separate and distinct bids (i.e., Bid 2, and Bid 3) are represented by bid-side entry 138. Further, Bid 1 is represented by bid-side entry 130; Bid 4, Bid 5, Bid 6, and Bid 7 are represented by bid-side entry 140; Bid 8 is represented by bid-side entry 142; Bid 9 is represented by bid-side entry 144; and Bid 10 is represented by bid-side entry 146. Further, notice that Bids 11-12 are not represented in bid-side table 148, as they are less than the lower limit 112 of desired price range 108.

Process 10 includes a bid-side aggregate calculation process 54 for calculating the bid-side aggregate value 136 for each bid-side entry. As with ask-side aggregate calculation process 46, bid-side aggregate calculation process 54 determines the bid-side aggregate value 136 for a particular bid-side entry by summing the value of the lot size for that particular bid-side entry with the lot sizes of all preceding bid-side entries included in bid-side table 148. For example, the aggregate value for bid-side entry 130 is [10], the aggregate value for bid-side entry 138 is [1019, i.e., 10+1009], the aggregate value for bid-side entry 140 is [1023, i.e., 10+1009+4], and so forth.

Similar to that of ask-side entries, a tabular sorting process 56 sorts bid-side entries (e.g., 130, 138, 140, 142, 144, 146) in accordance with a user-defined sorting parameter, such as ascending or descending bid prices, ascending or descending lot sizes, etc. This enables market participant 20 to group and order the bid-side entries within bid-side table 148 in accordance with their personal preferences. Again, like ask-side table 128, bid-side entries within bid-side table 148 are typically sorted by bid price (as shown in FIG. 2).

Bid-side aggregated display process 50 displays bid-side entries so that bid-side table 148 is essentially a mirror image of ask-side table 128. Specifically, the columns in bid-side table 148 are arranged in a fashion so that they are in the opposite order (i.e., when moving across the tables 128, 148 in a common direction) to that of ask-side table 128. The columns of these tables are essentially mirrored around an imaginary centerline 150. For example, column 116 and column 132 (i.e., ask prices and bid prices respectively) are the closest columns to centerline 150. Further, column 118 and column 134 (i.e., ask-side and bid-side lot sizes respectively) are the second closest columns to centerline 150. And finally, column 120 and column 136 (i.e., ask-side and bid-side aggregate values respectively) are furthest columns away from centerline 150.

Process 28 includes a display deactivation process 58 that allows market participant 20 to control the content of summarized display 100. Specifically, display deactivation process 52 allows market participant 20 to selectively deactivate either ask-side aggregated display process 42 or bid-side aggregated display process 50. Therefore, if market participant 20 is only interested in buying shares of XYZ corp., they can deactivate bid-side aggregated display process 50. Alternatively, if market participant 20 is only interested in selling shares of XYZ corp., they can deactivate ask-side aggregated display process 42. Typically, market participant 20 makes this selection (concerning what is to be deactivated) via summarized display 100. Summarized display 100 may include check boxes 152, 154, 156 that allow market participant 20 to display “bid-side only” (i.e., ask-side deactivated), “ask-side only” (i.e., bid side deactivated), or “bid-side & ask-side” (i.e., neither deactivated). Alternatively, a drop down menu (not shown) may be included to allow the market participant to select which (if any) process is deactivated.

As stated above, summarized display 100 allows market participant 20 to quickly and easily discern the trading activity associated with the specific security 106 that market participant 20 wishes to monitor, and select and purchase various groups of shares of that security. Accordingly, securities order execution process 10 includes a user selection process 30 that allows market participant 20 to select one or more of the ask-side entries 102₁₋ₙ or bid-side entries 104₁₋ₙ they are interested. This selection can occur in several different ways. For example, using a mouse or some other pointing device (not shown), the market participant can select (i.e., “click on”) the entries that they are interested in. Specifically, if market participant 20 selects ask-side entries, they would be interested in buying shares represented by that ask-side entry. If the market participant selects bid-side entries, they would be interested in selling shares to the market participants represented by that bid-side entry.

In addition to the above-described selection method (i.e., clicking on entries with a mouse), user selection process 30 may include an ask-side selection process 58 that allows a market participant 20 to select (typically for purchase) groups of ask-side entries. In order to facilitate this market participant selection of ask-side entries, summarized display 100 includes group selection buttons 158, 160, 162, 164 that are each assigned to a particular ask price. These buttons are dynamically updated by ask-side selection process 58 so that they accurately reflect the securities (e.g., XYZ corp.) currently being offered for sale on computerized trading system 16. For example, group selection button 158 represents shares of XYZ corp. available for $17.10. As discussed above, there are ninety-two of them, as represented by ask-side entry 114. Group selection button 160 represents shares of XYZ corp. available for $17.31. There are eleven-hundred-sixty of them, as represented by ask-side entry 122. By clicking on or otherwise selecting (with a mouse or other pointing device, not shown) any of these group selection buttons, market participant 20 can select groups of shares available for purchase at a particular ask price. Group selection buttons 166, 168 are unused in this example and, therefore, are not assigned to any ask-side entry, as there are only four ask-side entries (i.e., 114, 122, 124, 126).

As stated above, these group selection buttons are dynamically updated, so that if ask-side entry 114 is sold (i.e., purchased by another market participant), there would be no more shares of XYZ corp. available for $17.10 and, therefore, group selection button 158 would be removed by ask-side selection process 58. Further, assuming that no additional shares of XYZ corp. became available at a price lower than $17.50 (i.e., the upper limit 110 of price range 108), no additional group selection buttons would be generated and, therefore, the total number of group selection buttons would be reduced to three. Typically, group selection buttons 158, 160, 162, 164, 166, 168 are organized so that the ask price that each button is associated with increases as market participant 20 moves along any row of buttons from left to right.

A bid-side selection process 60 allows a market participant 20 to select (typically for the purpose of the market participant selling their securities) groups of bid-side entries that have a common bid price. In order to facilitate this market participant selection of bid-side entries, summarized display 100 includes group selection buttons 170, 172, 174, 176, 178, 180 that are each assigned to a particular bid price. These group selection buttons are dynamically updated by bid-side selection process 60 so that they accurately reflect the securities currently sought for purchase. For example, group selection button 170 represents shares sought for purchase at $17.09. As discussed above, there are ten of them, as represented by bid-side entry 130. Group selection button 172 represents shares available for $17.08. There are one-thousand-nine of them, as represented by bid-side entry 138. By clicking on or otherwise selecting (with a mouse or other pointing device, not shown) any of these group selection buttons, market participant 20 can select groups of shares that the other market participant (i.e., the market participant of the bid-side entry) wishes to purchase for a particular bid price.

These group selection buttons are also dynamically updated, so that if bid-side entry 130 is filled (i.e., someone else sold that market participant ten shares of XYZ corp. for $17.09 per share), there would be no more market participants willing to pay $17.09 for a share of XYZ corp. and, therefore, group selection button 170 would be removed by bid-side selection process 60. Further, assuming that no other market participants are willing to pay more than $16.50 (i.e., the lower limit 112 of price range 108) for a share of XYZ corp., no additional group selection buttons would be generated and, therefore, the total number of group selection buttons would be reduced to five. Typically, group selection buttons 170, 172, 174, 176, 178, 180 are organized so that the bid price that each button is associated with decrease as market participant 20 moves along any row of buttons from right to left, an arrangement that is a mirror image of the ask-side group selection buttons (i.e., 158, 160, 162, 164, 166, 168).

Once market participant 20 selects the entries they are interested in, an order may be executed based on that selection by user order execution process 32. In order to facilitate this order execution, summarized display 100 includes an order execution button 182 that allows market participant 20 to execute orders based on the selections made on summarized display 100. Therefore, if an ask-side entry is selected when the order is executed (i.e., order execution button 182 is clicked), the shares of the security 106 represented by that ask-side entry would be purchased by market participant 20. Alternatively, if a bid-side entry is selected when the order is executed, market participant 20 would sell their shares of the security 106 represented by that bid-side entry to the market participant(s) associated with that bid-side entry. Additionally, if both an ask-side entry and a bid-side entry are selected when the order is executed, market participant 20 will buy shares of XYZ corp. from a first market participant and also sell shares of XYZ corp. to a second market participant.

User order execution process 32 may also include an order confirmation process 62 that requires market participant 20 to confirm their order prior to that order being place. This confirmation would require market participant 20 to take some affirmative step to verify their intent to place the order. This can occur when market participant 20 clicks on an order confirmation button 184 that is included on summarized display 100 or appears as a separate pop-up window (not shown) once order execution button 182 is clicked.

Once the order is executed and confirmed (if necessary), securities order execution process 10 provides computerized trading system 16 with the information required to effectuate the trade (e.g., security symbol, seller name, buyer name, sell price, buy price, quantity, etc.).

While the lot sizes 118, 134 described above are stated as being in units of shares, it is possible for these numbers to also represent groups of one-hundred shares (commonly referred to as “round lots”), or any other amount of shares. In this scenario, ask-side entry 114 may represent an offer to sell ninety-two-hundred shares of XYZ corp.

While imaginary centerline 150 is shown as being a vertical centerline, this is not meant to imply that the ask-side and bid-side entries must be mirrored around a vertical (or any other angle) axis. For example, imaginary centerline 150 may be a horizontal centerline, such that ask-side and bid-side entries are arranged in multi-row format and, therefore, mirroring occurs about a horizontal axis.

Further, while bid-side aggregated display process 50 is described above as being configured to display the bid-side entries so that the bid-side table is essentially a mirror image of the ask-side table, it is possible for the same result to be achieved in a different manner. Specifically, the ask-side aggregated display process 42 may be configured to display the ask-side entries so that the ask-side table is essentially a mirror image of the bid-side table. This would achieve the same end result.

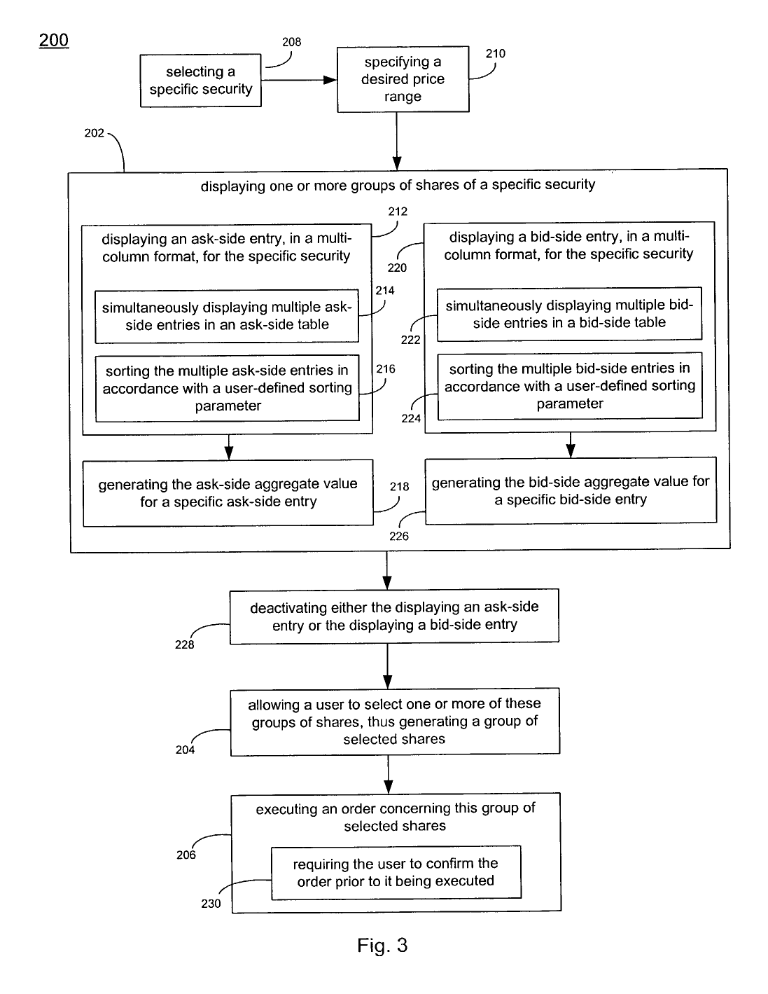

Referring to FIG. 3, there is shown a securities order execution method 200. One or more groups of shares are displayed 202 for a specific security that is traded on a securities market. These groups of shares are all within a desired price range that is specified by a market participant. A market participant is allowed 204 to select one or more of these groups of shares, thus generating a group of selected shares. An order is executed 206 concerning this group of selected shares.

The specific security traded on the securities market is selected 208 by the market participant. Further, the market participant specifies 210 the desired price range for the specific security.

An ask side entry is displayed 212, in a multi-column format, for each group of shares that represents shares of the security that are offered for sale by at least one market participant. Each ask-side entry includes an ask price, a lot size, and an aggregate value. When the market participant wishes to select a group of shares, this is done by selecting the ask-side entry associated with that group of shares. Multiple ask-side entries are simultaneously displayed 214, thus generating an ask-side table. These ask-side entries in this ask-side table are sorted 216 in accordance with a user defined parameter. An ask-side aggregate value is generated 218 for each ask-side entry, such that the ask-side aggregate value for a particular ask-side entry is equal to the lot size of that particular ask-side entry summed with the lot sizes of all preceding ask-side entries included in the ask-side table.

A bid-side entry is displayed 220, in a multi-column format, for each group of shares that represents shares of the specific security that are sought for purchase by at least one market participant. Each bid-side entry includes a bid-price, a lot size, and a bid-side aggregate value. When the market participant wishes to select a group of shares, this is done by selecting the bid-side entry associated with that group of shares. Each bid-side entry is displayed so that it is essentially a mirror image of each ask-side entry. Multiple bid-side entries are simultaneously displayed 222, thus generating a bid-side table. These bid-side entries in this bid side table are sorted 224 in accordance with a user defined parameter. A bid-side aggregate value is generated 226 for each bid-side entry, such that the bid-side aggregate value for a particular bid-side entry is equal to the lot size of that particular bid-side entry summed with the lot sizes of all preceding bid-side entries included in the bid-side table.

The market participant can selectively deactivate 228 the process of displaying 212 an ask-side entry or displaying 220 a bid-side entry, thus hiding the ask-side or bid-side tables, respectively. Any orders initiated by the market participant may need to be confirmed 230 prior to being completely executed.

The system described herein is not limited to the hardware embodiment described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Embodiments of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Embodiments of the system may also be implemented using integrated circuit blocks referred to as main memory, cache memory, or other types of memory that store electronic instructions to be executed by a microprocessor or store data that may be used in arithmetic operations.

A number of embodiments of the invention have been described. Nevertheless, it will be understood that various modifications may be made without departing from the spirit and scope of the invention.

What is claimed is:

1. A securities order execution process comprising:
an aggregated display process for displaying one or more groups of shares of a specific security that are traded on a securities market within a desired price range;
a user selection process for allowing a market participant to select one or more of the groups of shares, thus generating a group of selected shares; and
a user order execution process for executing an order concerning the group of selected shares.

2. The securities order execution process of claim 1 wherein the aggregated display process includes:
a security selection process for selecting the specific security traded on the securities market; and
a price range specification process for specifying the desired price range for the specific security.

3. The securities order execution process of claim 1 wherein the aggregated display process further includes:
an ask-side display process for displaying, in a multi-column format, an ask-side entry for each group of shares that represents shares of the specific security that are offered for sale by at least one market participant, wherein each ask-side entry includes an ask price, a lot size, and an ask-side aggregate value, and the user selection process is configured to allow the market participant to select the group of selected shares by selecting each ask-side entry associated with the group of selected shares.

4. The securities order execution process of claim 3 wherein the ask-side display process includes a tabular display process for simultaneously displaying multiple ask-side entries in an ask-side table.

5. The securities order execution process of claim 4 wherein the ask-side display process further includes a tabular sorting process for sorting the multiple ask-side entries in accordance with a user-defined sorting parameter.

6. The securities order execution process of claim 5 wherein the user-defined sorting parameter is chosen for the group consisting of: lot size; and ask price.

7. The securities order execution process of claim 5 wherein the ask-side display process further includes an ask-side aggregate calculation process for generating the ask-side aggregate value for a specific ask-side entry, wherein the ask-side aggregate value is equal to the lot size of the specific ask-side entry summed with the lot sizes of all preceding ask-side entries included in the ask-side table.

8. The securities order execution process of claim 3 wherein the aggregated display process further includes:
a bid-side display process for displaying, in a multi-column format, a bid-side entry for each group of shares that represents shares of the specific security that are sought for purchase by at least one market participant, wherein each bid-side entry includes a bid price, a lot size, and a bid-side aggregate value, and the user selection process is configured to allow the market participant to select the group of selected shares by selecting each bid-side entry associated with the group of selected shares;
wherein the bid-side display process is configured to display each bid-side entry such that it is essentially a mirror image of each ask-side entry.

9. The securities order execution process of claim 8 wherein the bid-side display process includes a tabular display process for simultaneously displaying multiple bid-side entries in a bid-side table.

10. The securities order execution process of claim 9 wherein the bid-side display process further includes a tabular sorting process for sorting the multiple bid-side entries in accordance with a user-defined sorting parameter.

11. The securities order execution process of claim 10 wherein the user-defined sorting parameter is chosen for the group consisting of: lot size; and bid price.

12. The securities order execution process of claim 10 wherein the bid-side display process further includes a bid-side aggregate calculation process for generating the bid-side aggregate value for a specific bid-side entry, wherein the bid-side aggregate value is equal to the lot size of the specific bid-side entry summed with the lot sizes of all preceding bid-side entries included in the bid-side table.

13. The securities order execution process of claim 8 wherein the aggregated display process further includes a display deactivation process for deactivating one of the ask-side display process and the bid-side display process.

14. The securities order execution process of claim 1 wherein the user order execution process includes an order confirmation process for requiring the market participant to confirm the order prior to it being executed.

15. A securities order execution method comprising:
displaying one or more groups of shares of a specific security that are traded on a securities market within a desired price range;
allowing a market participant to select one or more of these groups of shares, thus generating a group of selected shares; and
executing an order concerning this group of selected shares.

16. The securities order execution method of claim 15 wherein displaying one or more groups of shares includes:
selecting the specific security traded on the securities market; and
specifying the desired price range for the specific security.

17. The securities order execution method of claim 15 wherein displaying one or more groups of shares further includes:
displaying an ask-side entry, in a multi-column format, for each group of shares that represents shares of the specific security that are offered for sale by at least one market participant, wherein each ask-side entry includes an ask price, a lot size, and an ask-side aggregate value, and allowing a market participant to select is configured to allow the market participant to select the group of selected shares by selecting each ask-side entry associated with the group of selected shares.

18. The securities order execution method of claim 17 wherein displaying an ask-side entry includes simultaneously displaying multiple ask-side entries in an ask-side table.

19. The securities order execution method of claim 18 wherein displaying an ask-side entry further includes sorting the multiple ask-side entries in accordance with a user-defined sorting parameter.

20. The securities order execution method of claim 19 wherein displaying an ask-side entry further includes generating the ask-side aggregate value for a specific ask-side entry, wherein the ask-side aggregate value is equal to the lot size of that specific ask-side entry summed with the lot sizes of all preceding ask-side entries included in the ask-side table.

21. The securities order execution method of claim 17 wherein displaying one or more groups of shares further includes:
displaying a bid-side entry, in a multi-column format, for each group of shares that represents shares of the specific security that are sought for purchase by at least one market participant, wherein each bid-side entry includes a bid price, a lot size, and a bid-side aggregate value, and allowing a market participant to select is configured to allow the market participant to select the group of selected shares by selecting each bid-side entry associated with the group of selected shares;
wherein displaying a bid-side entry is configured to display each bid-side entry such that it is essentially a mirror image of each ask-side entry.

22. The securities order execution method of claim 21 wherein displaying a bid-side entry includes simultaneously displaying multiple bid-side entries in a bid-side table.

23. The securities order execution method of claim 22 wherein displaying a bid-side entry further includes sorting the multiple bid-side entries in accordance with a user-defined sorting parameter.

24. The securities order execution method of claim 23 wherein displaying a bid-side entry further includes generating the bid-side aggregate value for a specific bid-side entry, wherein the bid-side aggregate value is equal to the lot size of that specific bid-side entry summed with the lot sizes of all preceding bid-side entries included in the bid-side table.

25. The securities order execution method of claim 21 wherein displaying one or more groups of shares further includes deactivating one of displaying an ask-side entry and displaying a bid-side entry.

26. The securities order execution method of claim 15 wherein executing an order includes requiring the market participant to confirm the order prior to it being executed.

27. A computer program product residing on a computer readable medium having a plurality of instructions stored thereon which, when executed by a processor, cause that processor to:
display one or more groups of shares of a specific security that are traded on a securities market within a desired price range;
allow a market participant to select one or more of these groups of shares, thus generating a group of selected shares; and
execute an order concerning this group of selected shares.

28. The computer program product of claim 27 wherein the plurality of instructions further cause the processor to:
select the specific security traded on the securities market; and
specify the desired price range for the specific security.

29. The computer program product of claim 27 wherein the plurality of instructions further cause the processor to:
display an ask-side entry, in a multi-column format, for each group of shares that represents shares of the specific security that are offered for sale by at least one market participant, wherein each ask-side entry includes an ask price, a lot size, and an ask-side aggregate value, and allowing a market participant to select is configured to allow the market participant to select the group of selected shares by selecting each ask-side entry associated with the group of selected shares.

30. The computer program product of claim 29 wherein the plurality of instructions further cause the processor to simultaneously display multiple ask-side entries in an ask-side table.

31. The computer program product of claim 30 wherein the plurality of instructions further cause the processor to sort the multiple ask-side entries in accordance with a user-defined sorting parameter.

32. The computer program product of claim 31 wherein the plurality of instructions further cause the processor to generate the ask-side aggregate value for a specific ask-side entry, wherein the ask-side aggregate value is equal to the lot size of that specific ask-side entry summed with the lot sizes of all preceding ask-side entries included in the ask-side table.

33. The computer program product of claim 29 wherein the plurality of instructions further cause the processor to:
display a bid-side entry, in a multi-column format, for each group of shares that represents shares of the specific security that are sought for purchase by at least one market participant, wherein each bid-side entry includes a bid price, a lot size, and a bid-side aggregate value, and allowing a market participant to select is configured to allow the market participant to select the group of selected shares by selecting each bid-side entry associated with the group of selected shares;
wherein displaying a bid-side entry is configured to display each bid-side entry such that it is essentially a mirror image of each ask-side entry.

34. The computer program product of claim 33 wherein the plurality of instructions further cause the processor to simultaneously displaying multiple bid-side entries in a bid-side table.

35. The computer program product of claim 34 wherein the plurality of instructions further cause the processor to sort the multiple bid-side entries in accordance with a user-defined sorting parameter.

36. The computer program product of claim 35 wherein the plurality of instructions further cause the processor to generate the bid-side aggregate value for a specific bid-side entry, wherein the bid-side aggregate value is equal to the lot size of that specific bid-side entry summed with the lot sizes of all preceding bid-side entries included in the bid-side table.

37. The computer program product of claim 33 wherein the plurality of instructions further cause the processor to deactivate one of displaying an ask-side entry and displaying a bid-side entry.

38. The computer program product of claim 27 wherein the plurality of instructions further cause the processor to require the market participant to confirm the order prior to it being executed.
